(19) United States
(12) Patent Application Publication
(10) Pub. No.: US 2010/0257447 A1
(43) Pub. Date: Oct. 7, 2010

(54) ELECTRONIC DEVICE AND METHOD FOR GESTURE-BASED FUNCTION CONTROL

(75) Inventors: Hee Woon Kim, Gyeonggi-do (KR); Myeong Lo Lee, Seoul (KR); Yu Ran Kim, Seoul (KR); Sun Young Yi, Gyeonggi-do (KR); Joong Hun Kwon, Seoul (KR); Hyun Kyoung Kim, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/731,542

(22) Filed: Mar. 25, 2010

(30) Foreign Application Priority Data
Apr. 3, 2009 (KR) 10-2009-0028965

(51) Int. Cl. G06F 3/033; G06F 3/01

(52) U.S. Cl. 715/702; 715/863

(57) ABSTRACT

A method for a gesture-based function control for an electronic device having a touch-based input interface such as a touch screen is provided. While a selected mode is performed, a gesture launcher mode is activated in response to a user's request through a special function key or a multi-touch interaction. When receiving a user's gestural input in the gesture launcher mode, the electronic device executes a particular function corresponding to the user's gestural input.

### CLAIM OF PRIORITY

The present application claims the benefit of priority from Korean Patent Application No. 10-2009-0028965 filed Apr. 3, 2009 entitled “Electronic Device and Method for Gesture-Based Function Control”, the contents of which are hereby incorporated by reference in its entirety.

### BACKGROUND OF THE INVENTION

1. Field of the Invention

The present invention relates in general to a gesture-based function control technology for electronic devices. More particularly, the present invention relates to techniques for executing a particular function in an electronic device having a touch-based input interface such as a touch screen or a touch pad in response to a user's touch-based gestural input.

2. Description of the Related Art

With the dramatic advances in communication technologies, the advent of new techniques and functions in mobile devices has continued to maintain customers' interest in obtaining newer equipment with such techniques and features at a high level. In addition, various approaches to user-friendly interfaces have been introduced in the field of mobile devices.

Nowadays, many mobile devices employ a touch screen instead of or in addition to a traditional keypad as their input unit. Normally such a mobile device offers graphical icons on the touch screen to execute a particular function in response to a user's touch-based selection (which may include using a stylus) through a suitable icon. Alternatively or additionally, a special menu button or key may be offered to such a mobile device so that a user may activate a suitable menu option or item for executing a desired function.

These ways of executing functions in a mobile device with a touch screen may, however, have several shortcomings. In a case of using graphical icons, each individual icon needs a relatively larger display size on the touch screen in order to receive a reliable touch input from a user. By the way, the size-limited touch screen may fail to display several icons at the same time. In another case of using a menu button or key, a user's target menu option or item may typically exist in a menu tree structure with several depths. This target menu option may sometimes require too many steps to find a desired menu option or item, thus causing inconvenience to a user.

Therefore, there is a need in the art for a much simpler, easier and more convenient method for executing a desired function in a mobile device having a touch-based input surface, such as a touch screen.

### BRIEF SUMMARY OF THE INVENTION

An exemplary aspect of the present invention is to provide a method and apparatus for controlling various functions of an electronic device in a simpler, easier, more convenient and more intuitive way.

Another exemplary aspect of the present invention is to provide a method and apparatus for directly executing a desired function of an electronic device through a user's touch-based gestural input on a touch surface such as a touch screen, without requiring complicated steps for finding and accessing such a function.

Still another exemplary aspect of the present invention is to provide a method and apparatus for simply executing at least one of various functions assigned respectively to user's touch-based gestural inputs in an electronic device having a touch-based input interface such as a touch screen or a touch pad.

Yet another exemplary aspect of the present invention is to provide a method and apparatus for facilitating a user to take a gesture suitable for executing a desired function by displaying user gesture information which indicates various gesture types available for the execution of functions and by also displaying function information mapped with such user gesture information.

According to one exemplary aspect of the present invention, provided is a method for a gesture-based function control in an electronic device having a touch-based input interface, the method comprising: performing a selected mode in response to a user's request; activating a gesture launcher mode in response to a user's request in the selected mode; receiving a user's gestural input in the gesture launcher mode; and executing a particular function associated with the user's gestural input.

According to another exemplary aspect of the present invention, provided is a method for a gesture-based function control in an electronic device having a touch-based input interface, the method comprising: detecting an input event for activating a gesture launcher mode by the electronic device while performing a selected mode; activating the gesture launcher mode in response to the input event; receiving an input of a predefined user gesture while the detected input event is maintained; and executing a particular function based on function information corresponding to the user gesture.

According to still another exemplary aspect of the present invention, provided is an electronic device comprising: a touch-based input interface configured for entering into a gesture launcher mode in response to a predefined input event, and for receiving an input of a user gesture in the gesture launcher mode; and a control unit configured for executing a particular function in response to the user gesture input on the touch-based input interface.

Other exemplary aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIGS. 1 and 2 are front views illustrating examples of an initial action for activating a gesture launcher mode in a mobile device in accordance with exemplary embodiments of the present invention.

FIG. 3 is a flow diagram which illustrates a method for a gesture-based function control in a mobile device in accordance with an exemplary embodiment of the present invention.

FIG. 4 is a flow diagram which illustrates a method for a gesture-based function control in a mobile device in accordance with another exemplary embodiment of the present invention.

FIGS. 5 and 6 are screen views which illustrate an example of a gesture-based function control in a mobile device in accordance with an exemplary embodiment of the present invention.

FIGS. 7 and 8 are screen views which illustrate another example of a gesture-based function control in a mobile device in accordance with another exemplary embodiment of the present invention.

### DETAILED DESCRIPTION

Exemplary, non-limiting embodiments of the present invention will now be described more fully with reference to the accompanying drawings. The claimed invention may, however, be embodied in many different forms and should not be construed as limited to the exemplary embodiments set forth herein. The principles and features of the claimed invention may be employed in varied and numerous embodiments without departing from the scope of the invention.

Furthermore, well-known or widely used techniques, elements, structures, and processes may not be described or illustrated in detail to avoid obscuring appreciation of the present invention by a person of ordinary skill in the art. Although the drawings represent exemplary embodiments of the invention, the drawings are not necessarily to scale and certain features may be exaggerated or omitted in order to better illustrate and explain the present invention.

The present invention relates to a method and apparatus for a gesture-based function control in an electronic device. Particularly, exemplary embodiments of the present invention relate to a method and apparatus for simply executing various functions of an electronic device in response to a user's touch-based gestural input on a touch-based input interface such as a touch screen or a touch pad. In this disclosure, a user gesture or a user's gestural input refers to a user's input motion made on a touch-based input interface to express a predefined specific pattern.

According to exemplary embodiments of the present invention, when an electronic device receives a request for a gesture launcher mode while any other mode is enabled, the electronic device activates the gesture launcher mode and also keeps the existing mode enabled. Then, the electronic device recognizes a user gesture inputted in the gesture launcher mode and immediately executes a particular function corresponding to the inputted user gesture. In some exemplary embodiment of the present invention, the electronic device may additionally have a special function key for activating the gesture launcher mode, or may receive a multi-touch input for activating the gesture launcher mode through the touch-based input interface.

The present invention allows for a gesture-based control of a selected function of an electronic device. Specifically, the electronic device which has at least one of a touch screen and a touch pad enters into a gesture launcher mode through a specific physical key or a predefined multi-touch interaction. Then the electronic device receives a user's gestural input and, based on the received gestural input, executes a corresponding function. Exemplary Embodiments of the present invention are described hereinafter will employ a mobile device, also referred to as a portable device, a handheld device, etc., as a representative example of an electronic device. However, such examples are illustrative only and not to be considered as a limitation of the present invention. As will be understood by those skilled in the art, any other types of electronic devices may be favorably and alternatively used for the present invention.

For instance, electronic devices of this invention may include a variety of well-known or widely used mobile devices such as a mobile communication terminal, a personal digital assistant (PDA), a portable game console, a digital broadcasting player, a smart phone, etc. Additionally, display devices or players such as TV, LFD (Large Format Display), DS (Digital Signage), media pole, etc. may also be regarded as electronic devices of this invention, just to name some possibilities. Meanwhile, input units used for this invention may include, but not limited to, a touch screen, a touch pad, a motion sensor, a voice recognition sensor, a remote controller, a pointing device, and any other equivalents.

Although exemplary embodiments of this invention will use a configuration of a mobile device in order to describe hereinafter a method and an apparatus of this invention, a person of ordinary skill will understand and appreciate that the present invention is not limited to mobile devices and may be favorably applied to many other types of electronic devices.

Now, a mobile device having a touch-based input interface and a method for controlling a function of the mobile device though a user's touch-based gestural input in accordance with exemplary embodiments of this invention will be described hereinafter. The embodiments given below are, however, exemplary only and not to be considered as a limitation of the present invention. As will be understood by those skilled in the art, any other embodiments or variations may be also possible. In addition, although the following exemplary embodiments will use cases where the mobile device has a touch screen as a touch-based input interface, a person of ordinary skill in the art that the present invention is not limited to such cases and may be favorably applied to many other types of a touch-based input interface, such as a touch pad.

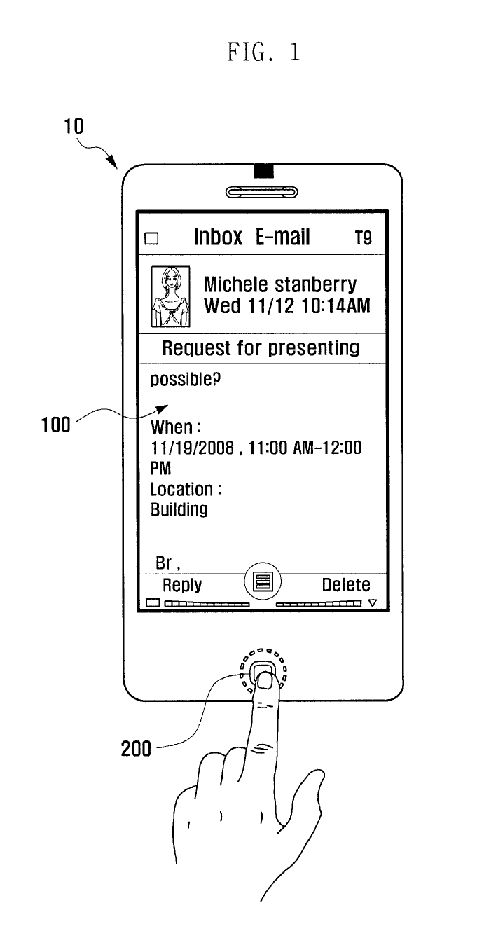

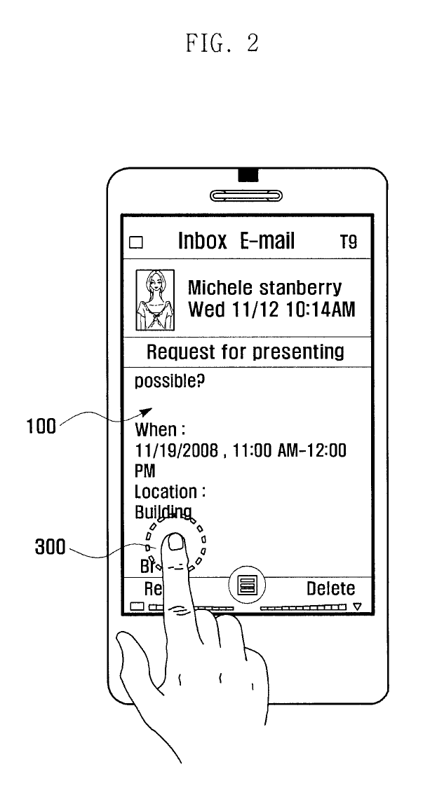

FIGS. 1 and 2 are front views of an initial action for activating a gesture launcher mode in a mobile device in accordance with exemplary embodiments of the present invention.

Specifically, FIG. 1 shows a case where the mobile device has a special function key 200 assigned to activate a gesture launcher mode. FIG. 2 shows another case where the mobile device has no special function key for activating a gesture launcher mode and instead receives a multi-touch input for activating a gesture launcher mode.

Although exemplary embodiments given below correspond to one of the above cases, the other case where the mobile device has the special function key 200 as shown in FIG. 1 and also operates in response to a multi-touch input may be further possible. Hereinafter, the special function key 200 will be referred to as a gesture mode shift key.

Referring now to FIG. 1, the mobile device (10) detects a user's input through the gesture mode shift key 200 while displaying on a screen an output data 100 created and displayed according to a specific mode of operation. That is, a user who desires to use a gesture-based function control can make an input event by pressing the gesture mode shift key 200. Herein, an input event may be a tap and hold event or a tap event, depending on gesture input types.

In a case of a tap and hold event, a user presses continuously on the gesture mode shift key 200 in order to activate a gesture launcher mode. The mobile device detects a user's input of a tap and hold event and then activates the gesture launcher mode. Particularly, when activating a gesture launcher mode, the mobile device may keep the display of the output data 100 created by operation of a specific mode. While a tap and hold event remains kept on the gesture mode shift key 200, a user takes a given gesture on the touch screen. The mobile device determines a particular function corresponding to a user gesture and then executes the determined function. In this case, a gesture launcher mode may be deactivated when a tap and hold event is halted, namely, when the gesture mode shift key 200 is released from a user's pressing. Alternatively, the mobile device may deactivate a gesture launcher mode if there is no gesture input for a given time.

In another case of a tap event, a user presses the gesture mode shift key 200 one time. The mobile device detects a user's input of a tap event and then activates the gesture launcher mode. Particularly, when activating the gesture launcher mode, the mobile device may keep the display of the output data 100 created by operation of a specific mode. After a tap event occurs, a user takes a given gesture on the touch screen. The mobile device determines a particular function corresponding to a user gesture and then executes the determined function. In this case, the gesture launcher mode may be deactivated when a subsequent tap event occurs again. For example, the mobile device may activate or deactivate the gesture launcher mode according to a toggling input. Alternatively, the mobile device may deactivate the gesture launcher mode if there is no gesture input for a given time.

Referring now to FIG. 2, while any output data 100 produced by the operation of an existing mode is displayed on a screen, the mobile device detects a user's input through the touch screen rather than through a key input. That is, a user who desires to use the gesture-based function control can create an input event by touching an arbitrary vacant location 300 in the displayed output data 100. Herein, an input event may be a tap and hold event or a tap event, depending on gesture input types.

In a case of a tap and hold event, a user presses continuously on the arbitrary vacant location 300 in order to activate the gesture launcher mode. The mobile device detects a user's input of a tap and hold event and then activates a gesture launcher mode. Particularly, when activating the gesture launcher mode, the mobile device may keep the display of the output data 100 created by operation of a specific mode. While the tap and hold event remains kept on the arbitrary vacant location 300 in the displayed output data 100, a user takes a given gesture on the touch screen. The mobile device determines a particular function corresponding to a particular user gesture and then executes the determined function. In this case, the gesture launcher mode may be deactivated when a tap and hold event is halted, namely, when the arbitrary vacant location 300 is released from a user's pressing. Alternatively, the mobile device may deactivate a gesture launcher mode if there is no gesture input for a given time.

In another case of a tap event, a user presses once the arbitrary vacant location 300 in the displayed output data 100 of the screen. The mobile device detects a user's input of a tap event and then activates the gesture launcher mode. Particularly, when activating a gesture launcher mode, the mobile device may keep the display of the output data 100 created by operation of a specific mode. After a tap event occurs, a user takes a given gesture on the touch screen. The mobile device determines a particular function corresponding to a user gesture and then executes the determined function. In this case, a gesture launcher mode may be deactivated when a tap event (e.g., a long press input more than a given time) occurs again on any arbitrary vacant location 300. That is, the mobile device may activate or deactivate a gesture launcher mode according to a toggling input. Alternatively, the mobile device may deactivate a gesture launcher mode if there is no gesture input for a given time.

As discussed hereinbefore, the mobile device activates and deactivates a gesture launcher mode, depending on a specific input event (e.g., a tap and hold event, a tap event) which occurs on the gesture mode shift key 200 or on the touch screen (or a touch pad). Then the mobile device can control a particular function depending on a user gesture inputted while a gesture launcher mode is activated.

In order to allow the aforesaid operation, the mobile device of this invention may include, for example, the touch screen which enters into a gesture launcher mode in response to a predefined input event and then receives a user gesture, and a control unit which controls a particular function in response to such a user gesture inputted on the touch screen.

The mobile device according to some exemplary embodiments of the present invention may have specially the gesture mode shift key 200 used to activate a gesture launcher mode. In this case, if a given input event occurs on the gesture mode shift key 200, the control unit recognizes a user gesture received through the touch screen and then controls the execution of a particular function while or after the input event occurs. Alternatively or additionally, if a given input event occurs on the touch screen, the control unit recognizes a user gesture received through the touch screen and then controls the execution of a particular function while or after the input event occurs.

That is, exemplary embodiments of the present invention may allow activating the gesture launcher mode through the gesture mode shift key 200, or through any vacant location 300 in the displayed output data 100. Accordingly, a user gesture may be inputted while the gesture mode shift key 200 or the vacant location 300 is pressed continuously, namely, while a tap and hold event is occurring. Alternatively, a user gesture may be inputted after the gesture mode shift key 200 or the vacant location 300 is pressed once, namely, after a tap event occurs once.

Embodiments of the present invention will be exemplarily described hereinafter based on the assumption that the activation of a gesture launcher mode and the input of a user gesture are made depending on a tap and hold event. Now, a method for a gesture-based function control in a mobile device having a touch-based input interface will be described in detail.

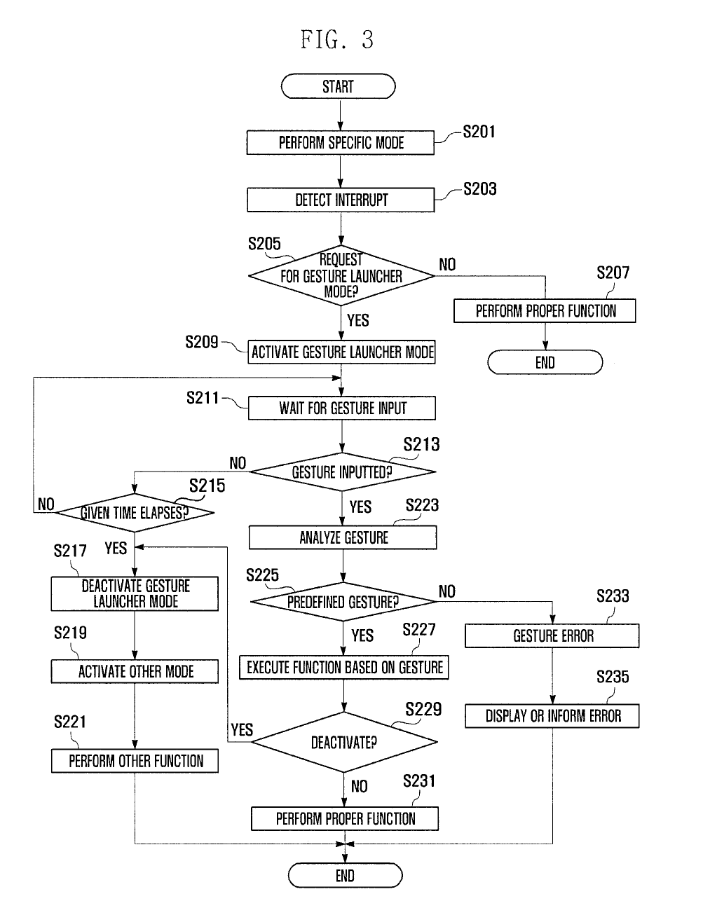

FIG. 3 is a flow diagram which illustrates exemplary operation of a method for a gesture-based function control in a mobile device in accordance with an exemplary embodiment of the present invention.

Referring now to FIG. 3, at step (S201) the mobile device performs a specific one of its available modes and at step (S203) detects the occurrence of an interrupt in the existing specific mode. Then at step (S205) the mobile device determines whether the interrupt is a request for the activation of a gesture launcher mode. For instance, the mobile device may determine whether the interrupt comprises a tap and hold event which occurs on the gesture mode switch key or on any vacant location in the output data displayed depending on the existing specific mode.

If at step (S205), the interrupt is not a request for a gesture launcher mode, then at step (S207) the mobile device performs any proper function corresponding to the interrupt. For instance, if the interrupt is a request for a certain menu, the mobile device displays the requested menu. In another instance, if the interrupt is a selection input for a certain icon, the mobile device executes an application or a function corresponding to the selected icon.

If the interrupt at step (S205) is a request for a gesture launcher mode, then at step (S209) the mobile device activates a gesture launcher mode and at step (S211) waits for a user's gestural input. At this time, the mobile device may form an additional layer for receiving a user's gestural input on the screen, while keeping the display of the output data created by the operation of the aforesaid specific mode.

With continued reference to FIG. 3, the mobile device waits for a user's gestural input for a given time after activating a gesture launcher mode. That is, at step (213) the mobile device determines whether a user gesture is inputted in a gesture launcher mode. If there is no gestural input, then at step (S215) the mobile device further determines whether a predetermined time elapses. If a predetermined time does not elapse, the mobile device continues to wait for a user's gestural input in the aforesaid step S211.

If a predetermined time elapses, the mobile device deactivates a gesture launcher mode (step S217) and instead reactivates the specific mode in the aforesaid step S201 (step S219). Then at step (S221), the mobile device performs any proper function in response to a user's other input. For instance, if receiving again a request for the activation of a gesture launcher mode, the mobile device may again perform the aforesaid steps after returning to the step S209. Otherwise, the mobile device may execute any particular operation in response to a user's other input in the existing specific mode.

Meanwhile, if it is determined that a user gesture is inputted in the aforesaid step S213, the mobile device analyzes a user's gestural input (step S223) and determines whether a user's gestural input corresponds to one of predefined gestures (step S225). For these steps, the mobile device stores in advance a mapping table which defines relation between gesture information and function information. In the mapping table, gesture information indicates various types of user gestures available for a function control, namely, various gestural motions made by following given patterns (e.g., figures, alphabet, etc.). Such gesture information may include at least one user gesture type according to a user's setting. Similarly, function information may include at least one function according to a user's setting. Normally gesture information and function information is in a one-to-one correspondence. The following Table 1 shows an example of a mapping table.

TABLE 1

| Gesture | Function | |
|---|---|---|
| Information | Information | Remarks |
| A | Select All | Execute a function to select |
| | | all of a gestured region |
| C | Copy | Execute a function to copy |
| | | selected data |
| V | Paste | Execute a function to paste |
| | | copied data |
| → or ← | Select Partly | Execute a function to select a |
| | | dragged region |
| F | Search | Activate a search application |
| N | Memo Note | Activate a memo note |
| | | application |
| M | Message | Activate a message |
| | | application |
| . . . | . . . | . . . |

Table 1 indicates available user gestures which can be inputted by a user and by which corresponding functions or applications can be executed. Table 1 which shows gesture information, function information and their mapping relation is, however, exemplary only and is not to be considered in any way as a limitation of the present invention. As will be understood by those skilled in the art, any other gesture information, function information and their mapping relation may be also possible. In addition, such gesture information, function information and their mapping relation may edited, added or removed according to a user's setting, and may be downloaded from related servers (e.g., a manufacturer's server, an operator's server, etc.). Hereinafter, gesture information, function information and their mapping relation will be generically referred to as gesture mapping information.

Such gesture mapping information may be transmitted to or received from other mobile devices. Particularly, in some exemplary embodiments of this invention, the mobile device displays such gesture mapping information on a screen when activating a gesture launcher mode so that a user may intuitively perceive gesture mapping information predefined in the mobile device. Also, the display of such gesture mapping information may be overlapped on the existing output data in a specific mode.

Returning now to FIG. 3, as the result of determination in the aforesaid step S225, if a user's gestural input corresponds to one of predefined gestures as shown in Table 1, then at step (S227) the mobile device executes a particular function mapped with a user's gestural input. Related examples will be described infra.

Next, at step (S229), after a particular function is executed in response to a user's gestural input, the mobile device determines whether or not to deactivate the gesture launcher mode (step S229). As discussed above, the gesture launcher mode may be deactivated when a user gesture is not input until a given time elapses, when there is a user's request for inactivation, or when a tap and hold event is halted according as the gesture mode shift key or the arbitrary vacant location is released from a user's pressing. If deactivation is determined, the mobile device returns to the aforesaid step S217 and deactivates a gesture launcher mode.

However, if it is determined not to deactivate a gesture launcher mode, the mobile device performs any proper function in response to a user's other input (step S231). For instance, after executing a particular function in response to a specific user gesture, the mobile device recognizes other gestural input and then executes a corresponding function.

On the other hand, as the result of determination in the aforesaid step S225, if a user's gestural input does not correspond to any predefined gesture, the mobile device regards a user gesture as an error (step S233) and executes a predefined subsequent function (step S235). For instance, the mobile device may display an error message through a pop-up window, etc. and then wait for another user's input. In another case, the mobile device may display predefined gesture mapping information together with or after displaying an error message. Also, through this process, the mobile device may confirm a user's setting regarding gesture information and function information.

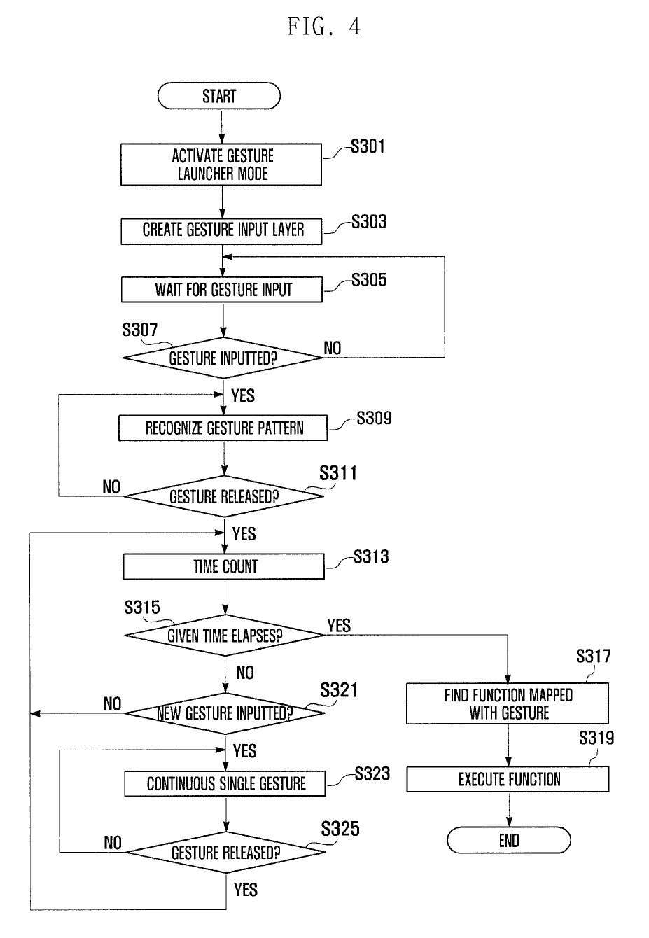

FIG. 4 is a flow diagram which illustrates an operational example of a method for a gesture-based function control in a mobile device in accordance with another exemplary embodiment of the present invention.

Referring now to FIG. 4, at step (S301) the mobile device activates a gesture launcher mode at a user's request and forms an additional layer for receiving a user's gestural input on the screen while keeping the display of the output data created by the operation of the existing specific mode (step S303). Then the mobile device then waits for a user's gestural input (step S305) and determines whether or not a user's gestural input has been initiated in a gesture launcher mode (step S307).

If a user's gestural input is initiated, then at step (S309) the mobile device recognizes a specific pattern made by a user gesture and determines a step (S311) whether a user gesture is released. If not released, such a user gesture continues to be recognized by mobile device in the previous step S309.

However, if a user gesture is released, the mobile device begins to count the time from the release of a user gesture (step S313). Specifically, a user gesture may be input again after being released, thus forming a series of gestural inputs. By counting the time after release, the mobile device can determine whether a current gesture is followed by any subsequent gesture. That is, if a new gesture is input within a given time after the preceding gesture is released, the mobile device then determines that a new gesture forms a gesture series together with the preceding gesture. Accordingly, the mobile device does not execute a particular function in response to a user gesture until a given time elapses without any additional gesture input.

For instance, referring to the aforesaid Table 1, a user who intends to input a gesture in the form of “A” may take a first gesture “Λ” and subsequently take a second gesture “-”. Therefore, when a certain user gesture “Λ” is inputted and released, the mobile device waits for the next input for a given time period. If the second gesture “-” is input within a given time, the mobile device regards the first gesture “Λ” and the second gesture “-” as a gesture series resulting in a gesture “A”. However, if no additional gesture is inputted for a given time, the mobile device executes a function corresponding to a user gesture “Λ” or displays an error message.

Returning now to FIG. 4, at step (S315) the mobile device determines whether or not a given time period elapses through a time count in the aforesaid step S313. If the given time period elapses, the mobile device finds a particular function mapped with a user's gestural input (step S317) and then at step (S319) executes a mapped function.

If the given time period does not elapse, at step (S321) the mobile device determines whether a new additional gesture is input. That is, the mobile device determines whether there is a gestural input subsequent to the released gestural input.

If no additional gesture is input, the mobile device returns to the aforesaid step S313 and continues to count the time. However, if any new gesture is additionally inputted, the mobile device regards a new gesture and the preceding gesture as a continuous single gestural input (step S323). Then at step (S325), the mobile device determines whether a new gesture is released. If a new gesture is released, the mobile device returns to the aforesaid step S311 and begins to count the time from the release of a new gesture. Thereafter, the above-discussed steps are repeated.

Heretofore, a method for a gesture-based function control in a mobile device is fully described. Now, practical examples of a gesture-based function control will be described in detail hereinafter. Examples given below are, however, exemplary only and are not to be considered as a limitation of the present invention. As will be understood by those skilled in the art, many other various examples or variations may be also possible that lie within the spirit of the invention and the scope of the appended claims.

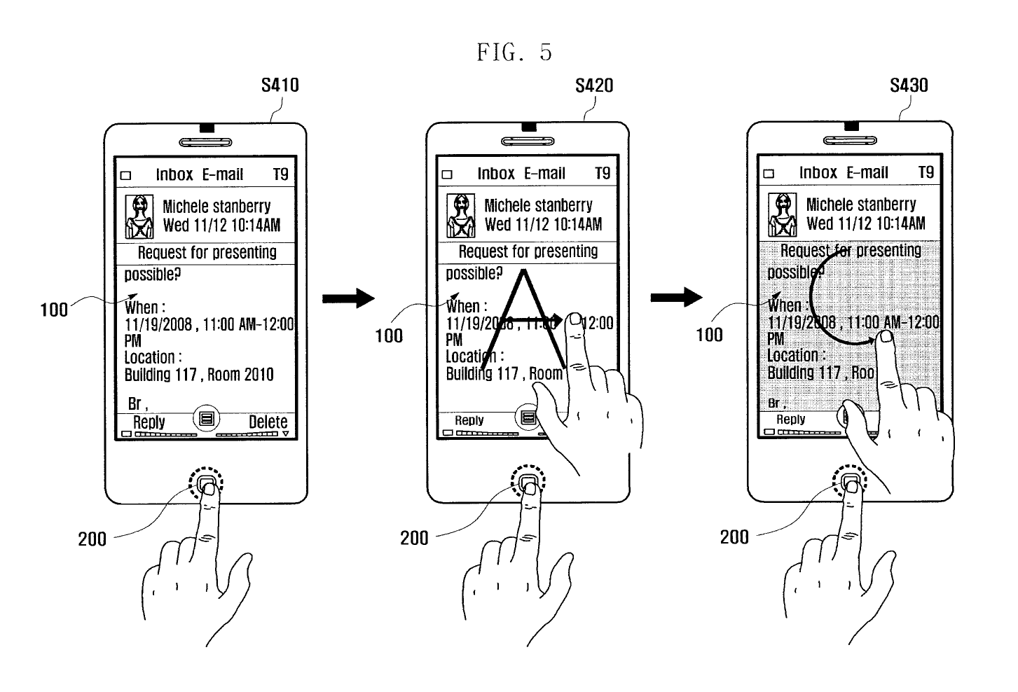

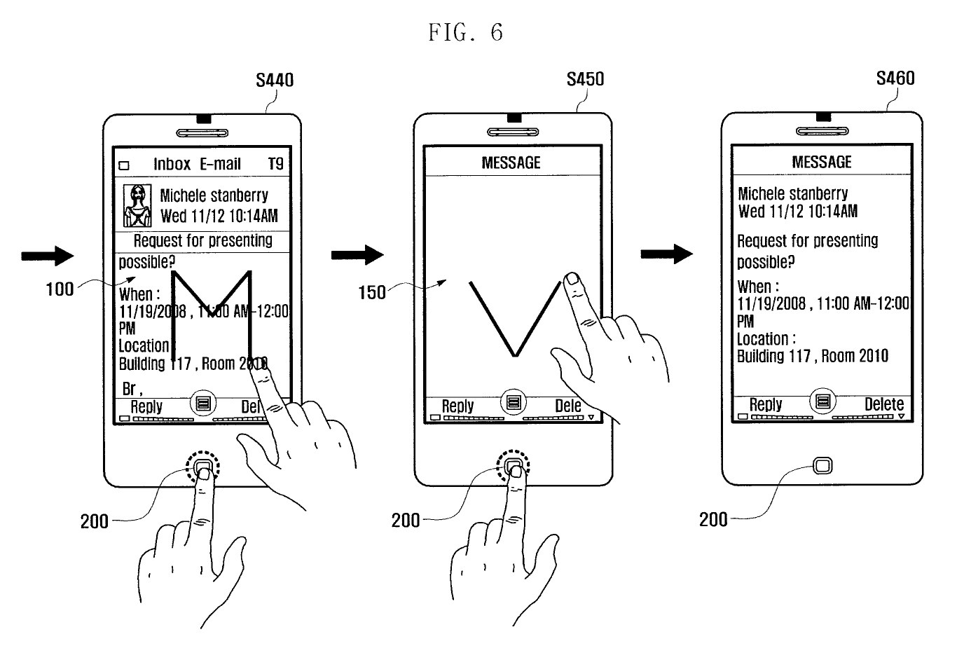

FIGS. 5 and 6 are screen views (i.e. screen shots) which illustrate an example of a gesture-based function control in a mobile device in accordance with an exemplary embodiment of the present invention. Particularly, FIGS. 5 and 6 correspond to a case where the gesture launcher mode is activated through the gesture mode shift key 200 separately equipped in the mobile device.

Referring again to FIGS. 5 and 6, at the outset, the mobile device enables a specific mode at a user's request. For instance, FIGS. 5 and 6 show examples of an e-mail mode, especially an inbox e-mail mode. Therefore, the mobile device displays any received e-mail as an output data 100.

While reading some e-mail, a user may desire to select and copy the content of the displayed output data 100. Therefore, first of all, a user has to be able to manipulate the mobile device to activate a gesture launcher mode. Specifically, a user inputs a tap and hold event by pressing the gesture mode shift key 200 as indicated by a reference number S410 in FIG. 5. Then the mobile device detects a tap and hold event and activates a gesture launcher mode while keeping the displayed output data 100.

Next, with continued reference to FIG. 5, as indicated by the reference number S420, a user inputs a certain gesture suitable for executing a desired function while keeping a tap and hold event, namely, while pressing continuously the gesture mode shift key 200. Here, for explanatory purposes it is assumed that a user's desired function is to select all of a gestured region. In addition, it is assumed that a corresponding gesture is a pattern “A” as shown in Table 1. Therefore, a user inputs a gesture “A” while keeping a tap and hold event by pressing continuously the gesture mode shift key 200. Then the mobile device recognizes a user gesture “A”, finds a particular function mapped with the recognized gesture “A”, and determines that a target function is to select all of a gestured region. Next, the mobile device executes a function to select all and thereby selects an object in a region where a user gesture is input. This input is shown in a screen view as indicated by a reference number S430 in FIG. 5. At this time, the mobile device may change a display state to intuitively inform a user that a requested function has been executed. For instance, when a function to select all is executed, a gestured region is highlighted as indicated by the reference number S430.

Next, as indicated by the reference number S430 in FIG. 5, a user inputs a new gesture suitable for executing other desired function while still keeping a tap and hold event without releasing the gesture mode shift key 200. Here, it is assumed that a user's desired function is to copy selected data and a corresponding gesture is a pattern “C” as shown in Table 1. Therefore, a user inputs a new gesture “C” while keeping a tap and hold event by pressing continuously the gesture mode shift key 200. Then the mobile device recognizes a user gesture “C”, finds a particular function mapped with the recognized gesture “C”, and determines that a target function is to copy selected data. Next, the mobile device executes a copy function and thereby copies an object in a region selected in the aforesaid state S420. At this time, although not illustrated in FIGS. 5 and 6, information on an object to be copied may be temporarily stored in a specific storage, such as a clipboard, of the mobile device.

Meanwhile, a user may halt a tap and hold event by releasing the gesture mode shift key 200 from pressing in any state S420 or S430. Then the mobile device deactivates a gesture launcher mode and returns to an initial state before the aforesaid state S410.

Next, as indicated by a reference number S440 in FIG. 6, a user inputs a new gesture suitable for executing a desired application in the aforesaid state S430 while still keeping a tap and hold event without releasing the gesture mode shift key 200. Here, it is assumed that a user's desired application is a message application which allows a user to write a message, and a corresponding gesture is a pattern “M” as shown in Table 1. Therefore, a user inputs a new gesture “M” while keeping a tap and hold event by pressing continuously the gesture mode shift key 200. Then the mobile device recognizes a user gesture “M”, finds a particular function mapped with the recognized gesture “M”, and determines that a target function is to activate a message application. Next, the mobile device executes a message application and thereby offers related output data 150 on a screen as indicated by a reference number S450.

At this time, although not illustrated in FIGS. 5 and 6, a message application may be executed in a multitasking process. Therefore, while output data 150 related to a message application is being displayed, the preceding output data 100 related to an inbox e-mail may be also offered in the background.

Next, in the aforesaid state S450 shown in FIG. 6, a user inputs a new gesture suitable for executing other desired function while still keeping a tap and hold event without releasing the gesture mode shift key 200. Here, it is assumed that a user's desired function is to paste copied data and a corresponding gesture is a pattern “V” as shown in Table 1. Therefore, a user inputs a new gesture “V” while keeping a tap and hold event by pressing continuously the gesture mode shift key 200. Then the mobile device recognizes a user gesture “V”, finds a particular function mapped with the recognized gesture “V”, and determines that a target function is to paste copied data. Next, the mobile device executes a paste function and thereby pastes an object selected and copied in the aforesaid states S420 and S430. A reference number S460 (shown in FIG. 6) indicates a display state of resulting output data.

Then, a user can write a message including the pasted object and may further input a proper gesture to send the written message to a specific recipient device. Meanwhile, a user may halt a tap and hold event by releasing the gesture mode shift key 200 from pressing in the state S460. Therefore, the mobile device deactivates the gesture launcher mode. Then the mobile device may return to an initial state before the aforesaid state S410 while transferring a message application to a multitasking process. Alternatively, as indicated by the aforesaid S460, the mobile device may still offer a message write mode based on a message application in order to receive other type input other than a gestural input.

Although not illustrated in FIGS. 5 and 6, the mobile device may display gesture mapping information, discussed above in Table 1, on the existing displayed data 100 in the form of overlay when a tap and hold event occurs on the gesture mode shift key 200 in the above-discussed state S410, for example. Therefore, a user may intuitively perceive available gesture types and their corresponding functions, thus conveniently using a gesture-based function control.

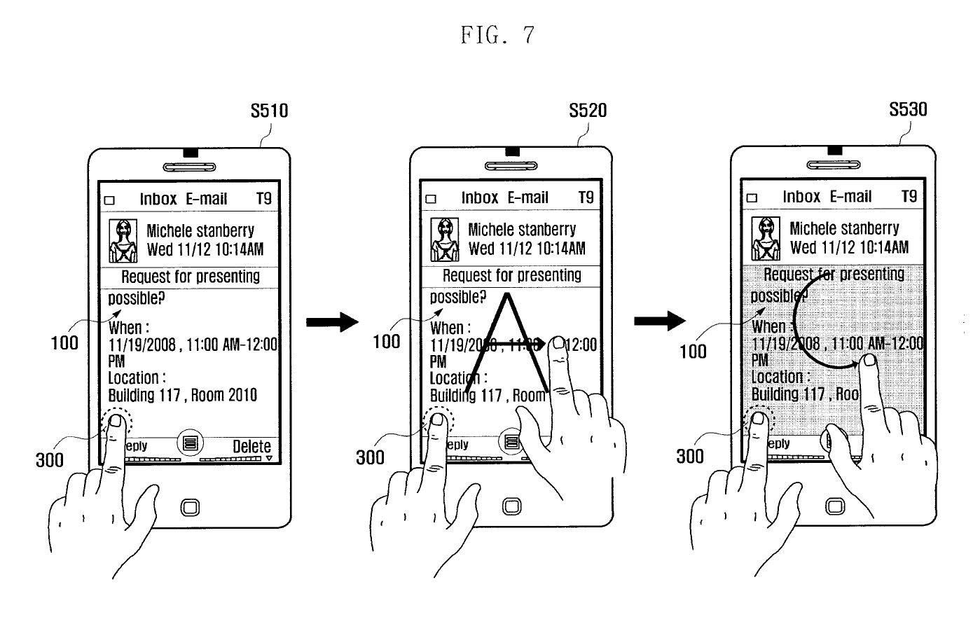

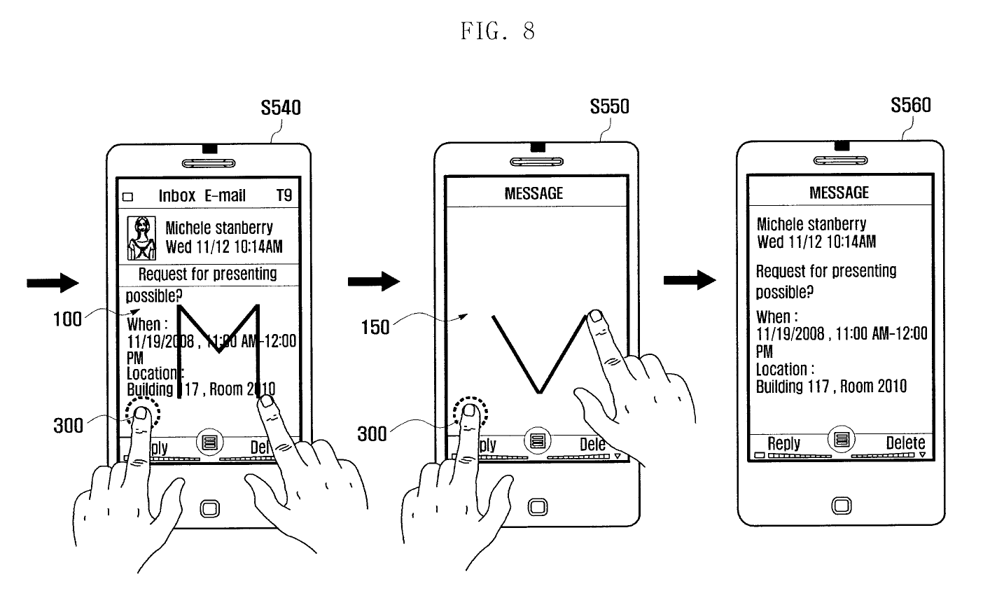

FIGS. 7 and 8 are screen views which illustrate another example of a gesture-based function control in a mobile device in accordance with another exemplary embodiment of the present invention. More particularly, FIGS. 7 and 8 correspond to a case where gesture launcher mode is activated through a multi-touch interaction on the touch screen of the mobile device.

Referring now to FIGS. 7 and 8, at the outset, the mobile device enables a specific mode at a user's request. FIGS. 7 and 8 exemplarily show an e-mail mode, especially an inbox e-mail mode, like FIGS. 5 and 6. Therefore, the mobile device displays any received e-mail as an output data 100.

While reading some e-mail, a user may desire to select and copy the content of the displayed output data 100. Therefore, first of all, a user has to manipulate the mobile device to activate the gesture launcher mode. Specifically, a user inputs a tap and hold event by pressing an arbitrary vacant location 300 in the displayed output data 100 as indicated by a reference number S510. Then the mobile device detects a tap and hold event and activates a gesture launcher mode while keeping the displayed output data 100.

Next, as indicated by a reference number S520 (FIG. 7), a user inputs a certain gesture suitable for executing a desired function while keeping a tap and hold event, namely, while pressing continuously the vacant location 300 in the displayed output data 100. Here, is assumed that a user's desired function is to select all of a gestured region. In addition, let's suppose that a corresponding gesture is a pattern “A” as shown in Table 1. Therefore, a user inputs a gesture “A” while keeping a tap and hold event by pressing continuously the vacant location 300 in the displayed output data 100. Then the mobile device recognizes a user gesture “A”, finds a particular function mapped with the recognized gesture “A”, and determines that a target function is to select all of a gestured region. Next, the mobile device executes a function to select all and thereby selects an object in a region where a user gesture is input. This function is shown in a screen view as indicated by a reference number S530 in FIG. 7. At this time, the mobile device may change a display state to intuitively inform a user that a requested function has been executed. For instance, when a function to “select all” is executed, a gestured region is highlighted as indicated by the reference number S530 in FIG. 7.

Next, as indicated by the reference number S530, a user inputs a new gesture suitable for executing other desired function while still keeping a tap and hold event without releasing the vacant location 300 in the displayed output data 100. Here, let's suppose that a user's desired function is to copy selected data and a corresponding gesture is a pattern “C” as shown in Table 1. Therefore, a user inputs a new gesture “C” while keeping a tap and hold event by pressing continuously the vacant location 300 in the displayed output data 100. Then the mobile device recognizes a user gesture “C”, finds a particular function mapped with the recognized gesture “C”, and determines that a target function is to copy selected data. Next, the mobile device executes a copy function and thereby copies an object in a region selected in the aforesaid state S520. At this time, although not illustrated in FIGS. 7 and 8, information on an object to be copied may be temporarily stored in a specific storage, such as a clipboard, of the mobile device.

Meanwhile, a user may halt a tap and hold event by releasing the vacant location 300 in the displayed output data 100 from pressing in any state S520 or S530. Then the mobile device deactivates a gesture launcher mode and returns to an initial state before the aforesaid state S510.

Next, as indicated by a reference number S540 in FIG. 8, a user inputs a new gesture suitable for executing a desired application in the aforesaid state S530 while still keeping a tap and hold event without releasing the vacant location 300 in the displayed output data 100. Here, let's suppose that a user's desired application is a message application which allows a user to write a message, and a corresponding gesture is a pattern “M” as shown in Table 1. Therefore, the user inputs a new gesture “M” while keeping a tap and hold event by pressing continuously the vacant location 300 in the displayed output data 100. Then the mobile device recognizes the user gesture “M”, finds a particular function mapped with the recognized gesture “M”, and determines that a target function is to activate a message application. Next, the mobile device executes a message application and thereby offers related output data 150 on a screen as indicated by a reference number S550.

At this time, although not illustrated in FIGS. 7 and 8, a message application may be executed in a multitasking process. Therefore, while output data 150 related to a message application is being displayed, the preceding output data 100 related to an inbox e-mail may be also offered in the background of the display.

Next, in the aforesaid state S550, a user inputs a new gesture suitable for executing another desired function while still keeping a tap and hold event without releasing the vacant location 300 in the displayed output data 100. Here, let's suppose that a user's desired function is to paste copied data and a corresponding gesture is a pattern “V” as shown in Table 1. Therefore, a user inputs a new gesture “V” while keeping a tap and hold event by pressing continuously the vacant location 300 in the displayed output data 100. Then the mobile device recognizes a user gesture “V”, finds a particular function mapped with the recognized gesture “V”, and determines that a target function is to paste copied data. Next, the mobile device executes a paste function and thereby pastes an object selected and copied in the aforesaid states S520 and S530. A reference number S560 indicates a display state of resulting output data.

Then, a user can write a message including the pasted object and may further input a proper gesture to send the written message to a specific recipient device. Meanwhile, a user may halt a tap and hold event by releasing the vacant location 300 in the displayed output data 100 from pressing in the state S560. Therefore, the mobile device deactivates the gesture launcher mode. Then the mobile device may return to an initial state before the aforesaid state S510 while transferring a message application to a multitasking process. Alternatively, as indicated by the aforesaid S560, the mobile device may still offer a message write mode based on a message application in order to receive other type input other than a gestural input.

Although not illustrated in FIGS. 7 and 8, the mobile device may display gesture mapping information, discussed above in Table 1, on the existing displayed data 100 in the form of overlay when a tap and hold event occurs on the vacant location 300 in the displayed output data 100 in the above-discussed state S510, for example. Therefore, a user may intuitively perceive available gesture types and their corresponding functions, thus conveniently using a gesture-based function control.

Described heretofore are practical examples of a gesture-based function control in a case where a tap and hold event is used to activate a gesture launcher mode. These are, however, exemplary only and not to be considered as a limitation of the present invention. As will be understood by those skilled in the art, any other various examples or variations may be also possible. For instance, a gesture launcher mode may be activated or deactivated depending on a tap event such as a toggling input on the gesture mode shift key. Specifically a gesture launcher mode is activated when a tap event occurs once on the gesture mode shift key, and then deactivated when such a tap event occurs again on the gesture mode shift key.

On the other hand, reference numbers from S410 to S460 in FIGS. 5 and 6 and reference numbers from S510 to S560 in FIGS. 7 and 8 are used to indicate an exemplary sequence of steps or states in connection with user's gestural inputs and related function execution. This sequence is, however, merely one example for illustration and not to be considered as a limitation of the present invention. Of course, any other various examples or variations may be possible practically. For instance, even though a gesture launcher mode is deactivated after a copy function is executed in the state S530 in FIG. 7, the rest of the steps from S540 in FIG. 8 may be continued when a gesture launcher mode is activated again at a user's request after some operation is performed.

The mobile device according to this invention may include many kinds of mobile communication terminals based on various communication protocols in a variety of communication systems. Also, the mobile device of this invention may include, but not limited to, a portable multimedia player (PMP), a digital broadcasting player, a personal digital assistant (PDA), a game console, a smart phone, a music player, a car navigation system, and any other kinds of portable or handheld devices, just to name a few of the many possibilities.

Although the above-discussed exemplary embodiments of this invention employ a touch screen as an input unit for receiving a user gesture, an input unit available for the present invention is not limited to the touch screen. Any other various touch interfaces such as a touch pad may be alternatively or additionally used for this invention. Additionally, the mobile device according to this invention has both the touch screen and the touch pad, a user gesture may be input through at least one of both. Also, the touch pad may be used to detect the occurrence of an input event for activating a gesture launcher mode.

In the meantime, although exemplary embodiments of the present invention described hereinbefore employ a mobile device as an example of electronic devices, the present invention is not limited to a case of the mobile device. As will be understood by those skilled in the art, any other types of electronic devices which have a suitable input unit for receiving a user's touch-based gestural input may also be favorably applied to this invention. Input units available for this invention may include, but not limited to, a motion sensor which recognizes a user's motion and thereby creates a resulting gestural input signal, a touch pad or a touch screen which creates a gestural input signal according to contact and movement of a finger, a stylus pen, etc., and a voice recognition sensor which recognizes a user's voice and thereby creates a resulting gestural input signal.

Furthermore, in addition to a great variety of mobile devices (e.g., a mobile phone, a PDA, a smart phone, a PMP, a music player, a DMB player, a car navigation system, a game console, and any other kinds of portable or handheld devices), the electronic device of this invention may include a variety of display devices or players (e.g., TV, LFD, DS, media pole, etc.). Besides, a display unit used for the electronic device may be formed of various well-known display devices such as a liquid crystal display (LCD), a plasma display panel (PDP), an organic light emitting diodes (OLED), or any type of thin film technology display and any other equivalents of all the previous examples.

In some cases, where this invention is embodied in the display device, the input unit may be formed of the touch pad, the touch screen, etc., which may be integrated with the display device or may be provided in the form of a separate unit. Here, a separate unit refers to a device which has a gyro sensor, an accelerator sensor, an IR LED, an image sensor, a touch pad, a touch screen, etc., and which is configured to recognize a motion or a pointing action. For example, such a separate unit may be formed of a remote controller, which has a keypad to receive a user's button pressing input. By recognizing a motion or a pointing action, such a separate unit may offer a resulting control signal to the electronic device through a wired or wireless communication. The electronic device may therefore use such a control signal for gesture-based operation.

According to a method for a gesture-based function control in an electronic device provided by this invention, a process of executing a particular function in the electronic device may become simpler and more convenient. Specifically, this invention may allow easier and faster execution of a selected function or application in response to a user gesture input through the touch screen or the touch pad in a gesture launcher mode activated by using a gesture shift key or a multi-touch touch interaction. This easier and faster execution of a selected function may enhance a user's convenience in use of electronic devices.

Also, according to the present invention, since predefined gesture information and function information mapped therewith may be offered on an idle screen or on a currently displayed output data when a gesture launcher mode is activated, a user may intuitively perceive available gesture types and their functions.

Additionally, according to the present invention, after entering into a gesture launcher mode, an electronic device may keep the preceding mode enabled. That is, it is possible for the electronic device to receive a user's gestural input in a state where any output data of the preceding mode remains displayed. Therefore, a user may intuitively manipulate the electronic device while perceiving displayed data in good order.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been particularly shown and described with reference to several exemplary embodiments thereof, it will be understood by those skilled in the art that various changes in form and details may be made therein without departing from the spirit and scope of the invention as defined by the appended claims.

What is claimed is:

1. A method for a gesture-based function control in an electronic device having a touch-based input interface, the method comprising:
performing a selected mode in response to a user's request;
activating a gesture launcher mode in response to a user's request in the selected mode;
receiving a user's gestural input in the gesture launcher mode; and
executing a particular function associated with the user's gestural input.

2. The method of claim 1, wherein the activating of the gesture launcher mode includes:
detecting an occurrence of an input event for the activation of the gesture launcher mode; and
activating the gesture launcher mode in response to the detected input event while keeping the selected mode in an enabled state.

3. The method of claim 2, wherein the input event occurs via detection of a gesture mode shift key equipped in the electronic device being actuated.

4. The method of claim 2, wherein the input event occurs through detection of contact in an arbitrary location on the touch-based input interface.

5. The method of claim 2, wherein the receiving of the user's gestural input occurs while the input event is maintained after activating the gesture launcher mode.

6. The method of claim 2, wherein the receiving of the user's gestural input occurs while the input event is halted after activating the gesture launcher mode.

7. A method for a gesture-based function control in an electronic device having a touch-based input interface, the method comprising:
detecting an input event for activating a gesture launcher mode by the electronic device while performing a selected mode;
activating the gesture launcher mode in response to the input event;
receiving an input of a predefined user gesture while the detected input event is maintained; and
executing a particular function based on function information corresponding to the user gesture.

8. The method of claim 7, wherein the input event occurs by a gesture mode shift key equipped in the electronic device being actuated or by an arbitrary location of the touch-based input interface being touched.

9. The method of claim 8, wherein the input event includes a tap-and-hold event which occurs on the gesture mode shift key, and wherein the particular function is executed in response to the user gesture being input while the tap-and-hold event is maintained on the gesture mode shift key.

10. The method of claim 8, wherein the input event includes a tap-and-hold event which occurs on the arbitrary location of the touch-based input interface, and wherein the particular function is executed in response to the user gesture being input while the tap-and-hold event is maintained on the arbitrary location of the touch-based input interface.

11. The method of claim 7, further comprising:
forming an additional layer for receiving the user gesture on a currently displayed output data when or after the gesture launcher mode is activated.

12. The method of claim 7, wherein the gesture launcher mode is activated while continuing to display output data created in the selected mode.

13. The method of claim 12, wherein the user gesture is inputted while display of the output data is maintained.

14. The method of claim 7, further comprising:
displaying an output data created depending on the execution of the particular function.

15. The method of claim 7, further comprising:
deactivating the gesture launcher mode when the input event is halted.

16. An electronic device comprising:
a touch-based input interface configured for entering into a gesture launcher mode in response to a predefined input event, and for receiving an input of a user gesture in the gesture launcher mode; and
a control unit configured for executing a particular function in response to the user gesture input on the touch-based input interface.

17. The electronic device of claim 16, further comprising:
a gesture mode shift key for activating the gesture launcher mode.

18. The electronic device of claim 17, wherein the input event occurs through actuation of the gesture mode shift key, and wherein the control unit controls execution of the particular function in response to the user gesture while the input event is maintained on the gesture mode shift key.

19. The electronic device of claim 16, wherein the input event occurs through contact with an arbitrary location of the touch-based input interface, and wherein the control unit controls the execution of the particular function in response to the user gesture while the input event is maintained on the arbitrary location of the touch-based input interface.
